(19) United States
(12) Patent Application Publication
(10) Pub. No.: US 2003/0023650 A1
(43) Pub. Date: Jan. 30, 2003

(54) Adaptive filter for communication system

(76) Inventor: Apostolis Papathanasiou, Anthens (GR)

Correspondence Address: Hung Chang LIN, 8 Schindler Court, Silver Spring, MD, 20903, US

(21) Appl. No.: 09/911,764

(22) Filed: Jul. 25, 2001

(51) Int. Cl. G06F 17/10

(52) U.S. Cl. 708/322

(57) ABSTRACT

A three-step method for applying a Least Square Solver (LESS) is used to adapt a linear system such as an adaptive filter to a set of adaptation parameters, whose elements are usually complex-valued. In a first step a binary orthogonalization transformation (BOT) is used to transform from complex arithmetic to real number arithmetic. In a second step, two real computation number LESS are applied. In a third step, an inverse BOT is introduced to transform to complex number arithmetic.

### BACKGROUND OF THE INVENTION

(1) Field of the Invention

This invention relates to adaptive systems in the areas of communications and control, particularly to a real computation solver for systems of linear equations with complex-valued elements.

(2) Brief Description of Related Art

Adaptive filtering is widely used in communication systems to optimize the reception of signals. A sample of such a system was described in a paper by A. Klein and P. W. Baier, “Linear unbiased data estimation in mobile radio systems applying CDMA” IEEE Journal on Selected Areas in communications, vol. 1, pp. 1058-1066, 1993. In the areas of adaptive filtering, parameter estimation and system identification, linear prediction provides the means for adapting linear systems to a set of measurements or observations. The parameters required to perform this adaptation are extracted by solving overdetermined systems of linear equations of the desired system adaptation parameters, the elements of which are usually complex-valued. In general, a system of linear equations can be represented by the equation

Xa=d, (1)

where the measurements or observations are arranged in the matrix X of dimensions N×M, the vector d of length N contains a known or estimated sequence and a is the vector of length M with the desired system adaptation parameters. Among the possible methods for solving such systems of linear equations, the solution in the least squares sense, termed as Least Squares Solver (LESS) from now on, is the most widely used. Special cases of LESS are the well-known Least Mean Squares (LMS) as described by S. Haykin in Adaptive Filter Theory, Prentice Hall, 2^{nd} Ed., pp. 67-68, 1994, Recursive Least Squares (RLS) as described by E. Frantzeskakis and K. J. R. Liu, in “A Class of Square Root and Division Free Algorithms and Architectures for QRD-Based Adaptive Signal Processing”, IEEE Trans. On Signal Processing, volt,42, no.9, pp. 2455-2469, September 1994, and the Householder algorithms as described by K. J. R., S. F. Hsien and K. Yao in “Systolic Block Householder Transformation for RLS Algorithm with Two-Level Pipelined Implementation”, IEEE Trans. On Signal Processing, Vol.40, No.4, pp.946-958, April 1980.

However, the application of LESS is computationally complex. It is desirable to reduce the computational complexity without sacrificing performance, stability or convergence rate.

### SUMMARY OF THE INVENTION

An object of this invention is to reduce the complexity in implementing an adaptive filter. Another object of this invention is to reduce the computational complexity without sacrificing performance, stability and convergence.

These objects are achieved by a three step method for applying a LESS that enables a significant reduction of the computational complexity. In a first step, this method uses Lee's transformation, denoted herein as linear binary orthogonalization transformation (BOT), from complex number arithmetic to real number arithmetic. In a second step, two real computation LESS are applied. In a third step, an inverse BOT (IBOT) from real number arithmetic to complex number arithmetic is introduced. The IBOT is the counterpart of Lee's BOT and its output provides the desired complex-valued system adaptation parameters. Concerning the first step of the method, i.e. the introduction of the BOT, two types of BOT are proposed: The first one relies on Lee's transformation as described in A. Lee, “Centrohermitian and skew-centroheritian matices”, Linear Algebra and its Applications, volt 29, pp.205-210, 1980 and maps a complex-valued matrix of dimensions N×M onto two real-valued matrices, each of dimensions N×M. The second type of the BOT produces from a complex-valued matrix of dimensions N×M two real-valued matrices, each of dimensions N×M, by adding and subtracting the real and imaginary parts of the complex-valued matrix, respectively. Concerning the third step of the method, i.e. the introduction of the IBOT, two types of IBOT are proposed: The first one is the counterpart of the first type of the BOT presented above, while the second type of the IBOT is the counterpart of the second type of the BOT presented above.

Compared to the known method, i.e. the application of a complex computation LESS, the proposed technique achieves a significant reduction of the computational complexity without sacrificing performance, stability or convergence rate. Therefore, this technique is particularly appropriate for implementation of adaptive systems on programmable machines, as well as dedicated VLSI architectures in the areas of communications and automation control.

The innovations of this invention are:

1. Introduction of the IBOT that is the counterpart of the BOT relying on Lee's transformation.

2. Introduction of the BOT produced by adding and subtracting the real and imaginary parts of the complex-valued measurements or observations.

3. Introduction of the IBOT that is the counterpart of the BOT produced by adding and subtracting the real and imaginary parts of the complex-valued measurements or observations.

4. Combination of BOT with IBOT and real computation LESS in order to implement a complex computation LESS.

5. Application of two LESS in parallel or serially.

6. Application of these methods for temporal or spatial or joint temporal and spatial channel estimation or equalization, for carrier frequency estimation, for Direction Of Arrival (DOA) estimation or for joint carrier frequency and DOA estimation.

The advantages of this invention are:

1. Reducing the number of operations required for applying a LESS on a programmable machine like a Digital Signal Processor (DSP) by up to 50%.

2. Reducing the circuit area required for implementing a LESS on VLSI architectures by up to 25%.

3. Enabling the application of a larger size LESS with the available resources, resulting in a broadening of the range a LESS can be applied to.

4. When applying the BOT that relies on Lee's transformation, the accuracy of the desired system adaptation parameter estimate is increased due to the inherent forward-backward averaging (FBA) feature of this type of BOT.

Note: The dynamic ranges of the algorithm variables and the convergence characteristics are the same with the original complex-valued LESS.

### BRIEF DESCRIPTION OF THE DRAWINGS

FIG. 1 shows the Prior art: Serial complex computation LESS

FIG. 2 shows a Parallel real computation LESS according to the invention

FIG. 3A shows the structure of the first type BOT building block

FIG. 3B shows an alternative structure of the first type BOT building block

FIG. 3C shows a structure of the first type BOT

FIG. 3D shows a structure of the first type IBOT building block

FIG. 3E shows an alternative structure of the first type IBOT building block

FIG. 3F shows a structure of the first type IBOT

FIG. 4A shows structure of the second type BOT

FIG. 4B shows a structure of the second type IBOT

FIG. 5 shows a serial real computation LESS according to the invention

FIG. 6 shows a parallel real computation Constrained LESS (CLESS) according to the invention

### DETAILED DESCRPTION OF THE INVENTION

Prior Art:

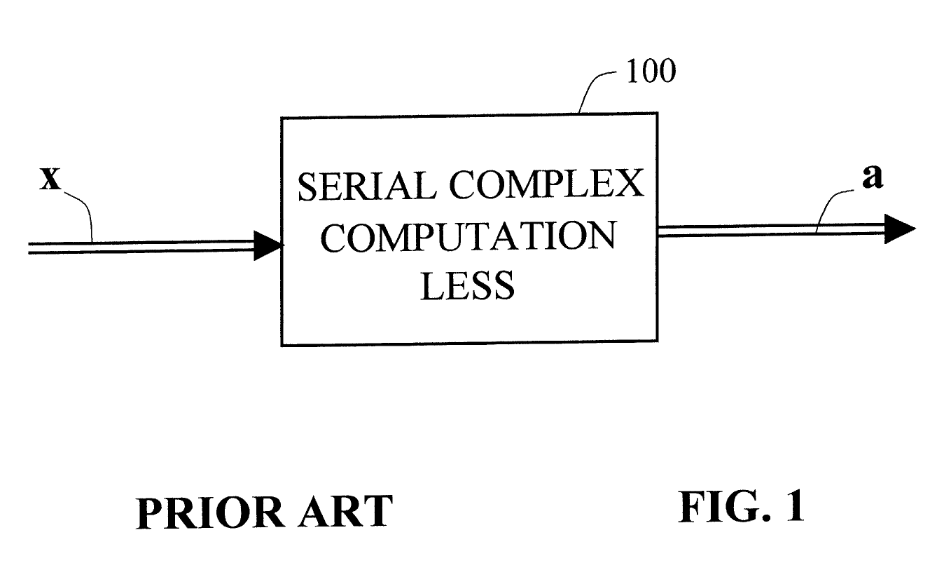

FIG. 1 illustrates the prior art in applying a LESS where all computations take place in complex number arithmetic. More specifically, the complex-valued input vector x of length M is fed to block 100 representing the serial complex computation LESS that produces at its output the complex-valued parameter vector a of length M. In the areas of communications and automation control, there might be a need for the recursive updating of the output parameter vector a depending on a sequence of input vectors x, i.e. there might be a need for adaptive linear prediction. In this case, block 100 in FIG. 1 represents a LESS of the recursive type like the RLS algorithm or the LMS algorithm and variations thereof, e.g., computation of the RLS algorithm by a systolic array or the use of the Householder transformation, the Cholesky decomposition, the Singular Value Decomposition (SVD) as described by S. L. Marple, Jr., in Digital spectral analysis with applications, Prentice-Hall, Englewood, N.J., 1987, or the QR Decomposition (QRD). However, there are also cases where the output parameter vector a is produced from the input vector x in a non-recursive or blockwise fashion. This situation can be described by the direct multiplication of the input vector x with a matrix A, both with the appropriate dimensions, and is typical for channel estimation and channel equalization in the areas of communications and automation control, see [6] for a representative work. In this case, block 100 in FIG. 1 represents a LESS of the non-recursive or block type, e.g., the Block Matched Filter Estimator (BMFE) or the Block Zero Forcing Estimator (BZFE) or the Block Minimum Mean Squared Error Estimator (BMMSEE). Summarizing, block 100 in FIG. 1 represents a serial complex computation LESS of the recursive or the block type.

Description/Derivations:

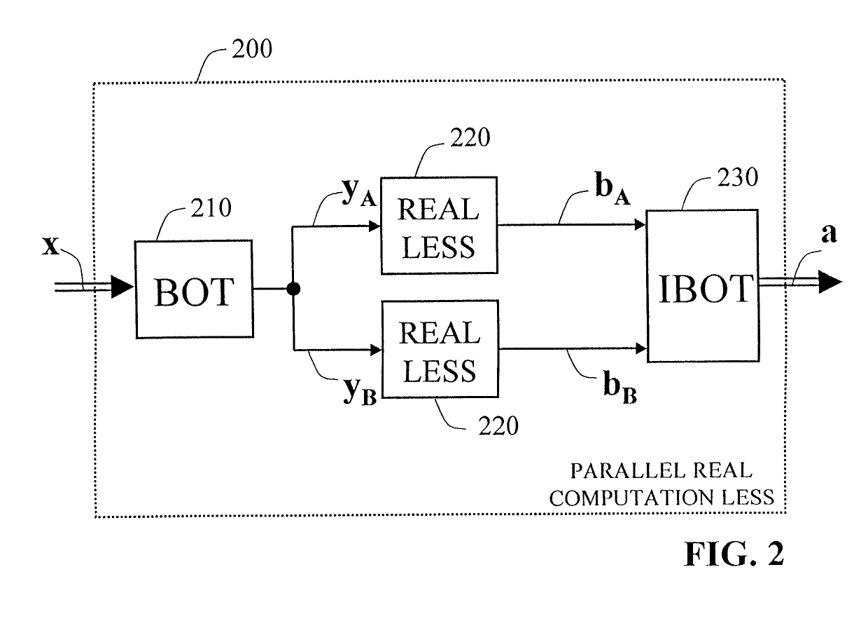

1. Parallel Real Computation LESS (FIG. 2): Our objective is to apply a LESS of the recursive or the block type by using real number arithmetic throughout, except for an initial BOT from complex number arithmetic to real number arithmetic and a final IBOT from real number arithmetic to complex number arithmetic. FIG. 2 illustrates the proposed architecture termed parallel real computation LESS 200. At first, the BOT 210 is applied to the complex-valued input vector x and produces two real-valued output vectors y_{A} and y_{B}. The details of the BOT 210 are described in the following Section 2 for the first type and in Section.3 for the second type of the proposed transformations. Then, each one of the real-valued vectors y_{A} and y_{B} is fed to block 220 representing a LESS, the computations of which exclusively take place in real number arithmetic. Note that the two LESS operate in a parallel fashion. Each LESS produces a real-valued output vector denoted as b_{A} and b_{B}, respectively. Then, an IBOT 230 is jointly applied to b_{A} and b_{B} so that the output vector a gives an equivalent result to the output of the serial complex computation LESS 100 illustrated in FIG. 1. The details of the IBOT 230 are described in the following Section 2 for the first type and in the following Section 3 for the second type of the proposed transformations.

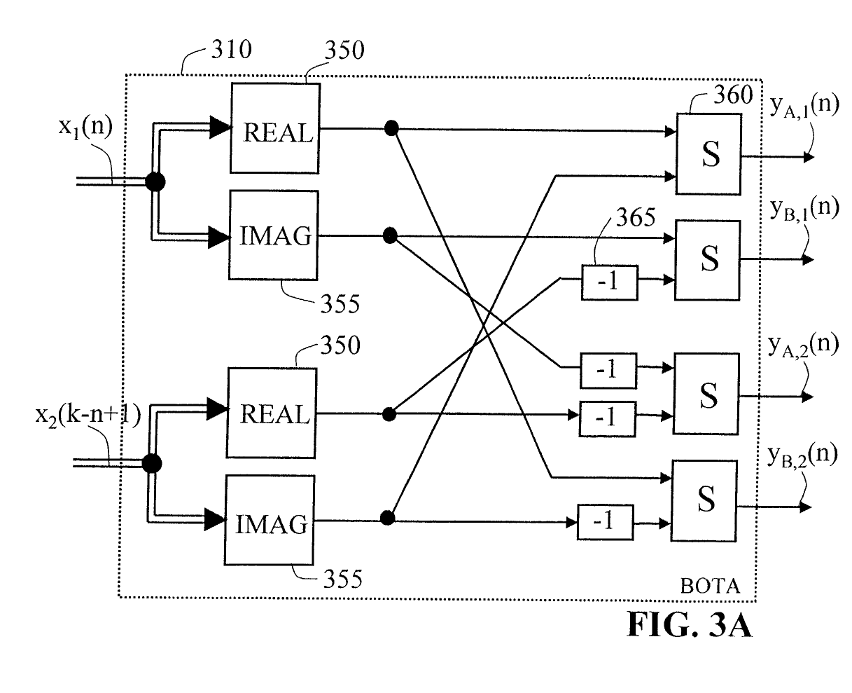

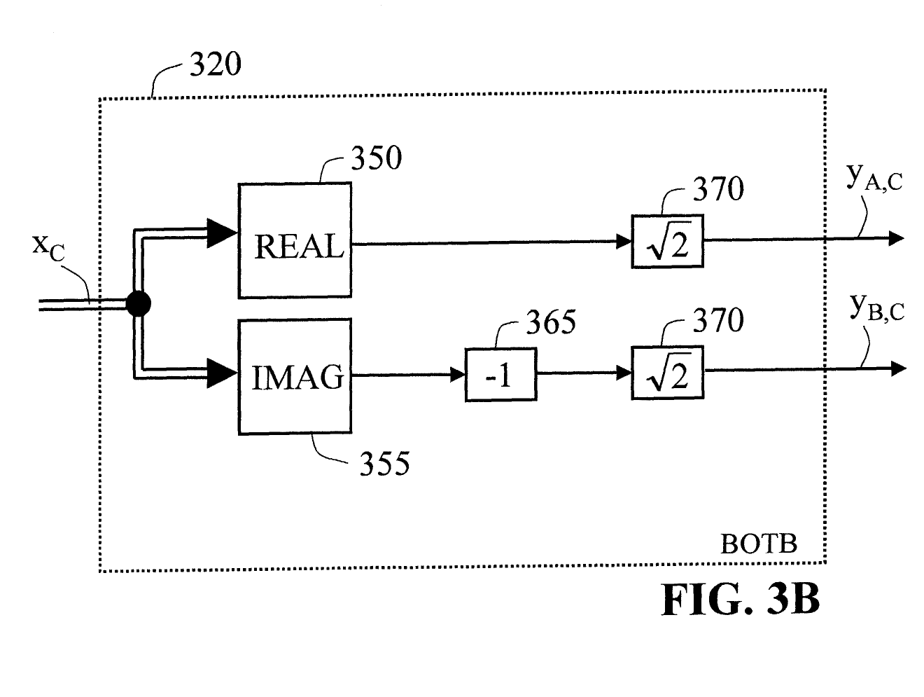

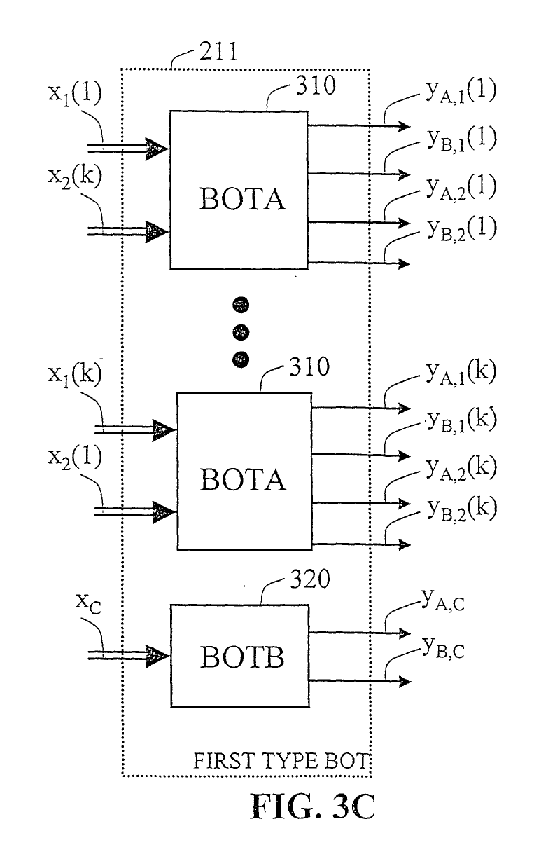

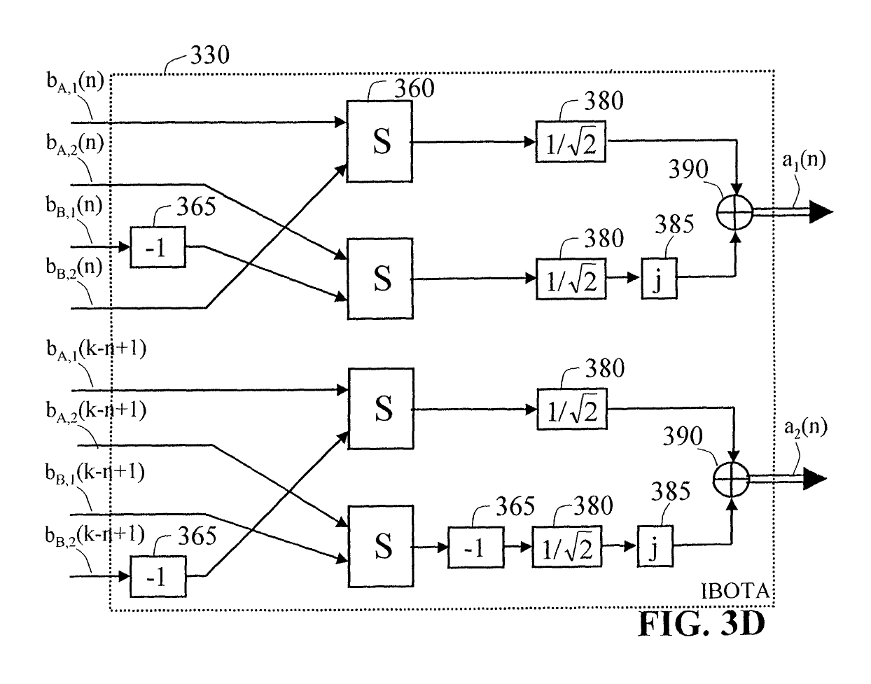

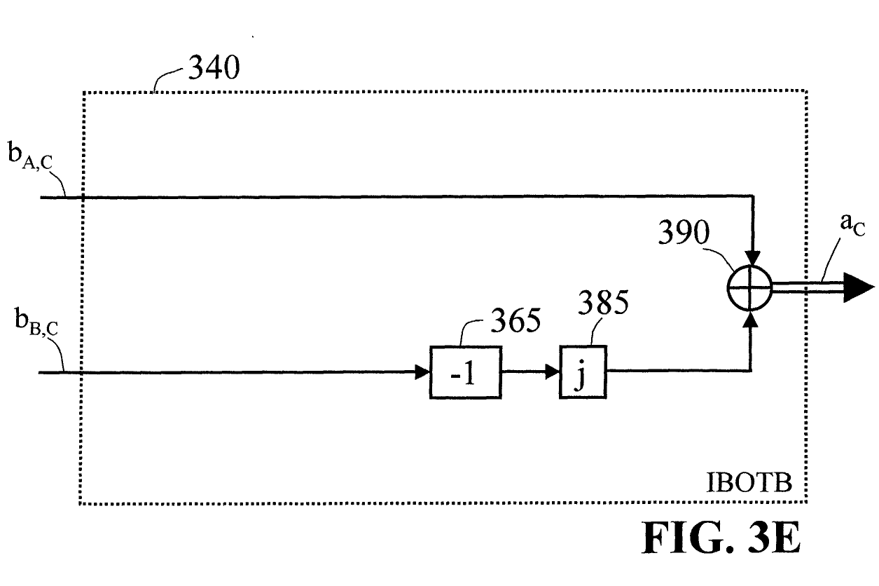

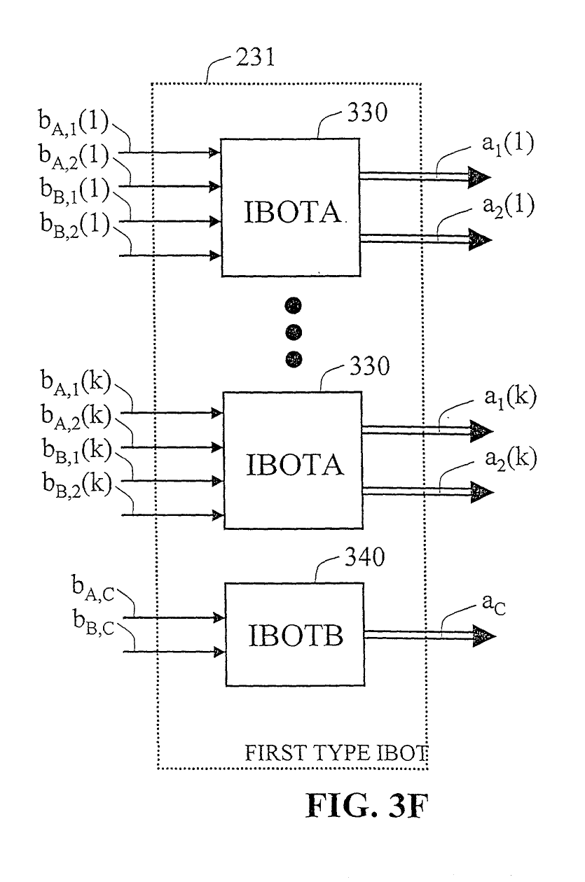

2. BOT and IBOT of the first type (FIG. 3): In this paragraph the details of the BOT 210 and the IBOT 230 of FIG. 2 are explained when the first type of the proposed transformations is used. Consider a complex-valued input vector x of length M, with M being a positive integer. In the general case where M is odd, i.e. M equals 2k+1 with k a non-negative integer, x may be written as

$$x = {[ {x}_{1}^{T} {x}_{c} {x}_{2}^{T} ]}^{T} , \qquad ( 2 )$$

where x₁ and x₂, both of length k, represent the upper and lower part of x and x_{c} represents the central element of x. Certainly, when M is even, the central element x_{c} should be dropped. Then, according to Lee's transformation [2], setting out from x two real-valued vectors y_{A} and y_{B} each of length k are produced, the structure of which is in one-to-one correspondence with the structure of x, see (2), i.e.

$${y}_{A} = {[ {y}_{A , 1}^{T} {y}_{A , c} {y}_{A , 2}^{T} ]}^{T} and {y}_{B} = {[ {y}_{B , 1}^{T} {y}_{B , c} {y}_{B , 2}^{T} ]}^{T} . \qquad ( 3 )$$

The BOT is algebraically expressed by the equations

$$\begin{matrix}{y}_{A} = {[ Re \{ {x}_{1}^{T} + {x}_{2}^{* T} {Π}_{k} \} \sqrt{2} Re \{ {x}_{A , c} \} Im \{ {x}_{1}^{T} + {x}_{2}^{* T} {Π}_{k} \} ]}^{T} & ( 4 ) \\ {y}_{B} = {[ - Im \{ {x}_{1}^{T} - {x}_{2}^{* T} {Π}_{k} \} - \sqrt{2} I m \{ {x}_{A , c} \} R e \{ {x}_{1}^{T} - {x}_{2}^{* T} {Π}_{k} \} ]}^{T} , & ( 5 )\end{matrix}$$

where Re{ } and Im{ } denote the real and imaginary part of their complex argument—a complex-valued vector or a complex number—and πₖ denotes the k×k exchange matrix having ones on its antidiagonal and zeros elsewhere. According to (4) and (5), each element of the real-valued output vectors y_{A,1}, y_{A,2}, y_{B,1}, and y_{B,2} is produced from additions of two elements of the vectors x₁ and x₂, see (2). This operation is implemented by BOTA 310 shown in FIG. 3A, where the blocks 350 and 355 apply the operators Re{ } and Im{ } respectively, block 365 represents the sign inversion operation and block S 360 stands for the addition operation. Furthermore, the central elements of the real-valued output vectors y_{A} and y_{B} are directly extracted from the central element of the input complex-valued input vector x. This operation is implemented by BOTB 320 shown in FIG. 3B, where blocks 350 and 355 apply the operators Re{ } and Im{ } respectively, block 365 represents the sign inversion operation and block 370 is a multiplier with the constant quantity \sqrt{2}. The application of the first type BOT 211 to the total complex-valued input vector x is illustrated in FIG. 3C, where the blocks BOTA 310 and BOTB 320 are shown in FIG. 3A and FIG. 3B, respectively.

The counterpart IBOT of the first type BOT is introduced in the following. Let b_{A} and b_{B} express two real-valued vectors of length M. According to FIG. 2, these vectors represent the output of the two parallel real LESS of the proposed architecture. b_{A} and b_{B} are partitioned according to vectors y_{A} and y_{B} produced by the first type BOT, i.e.

$${b}_{A} = {[ {b}_{A , 1}^{T} {b}_{A , c} {b}_{A , 2}^{T} ]}^{T} and {b}_{B} = {[ {b}_{B , 1}^{T} {b}_{B , c} {b}_{B , 2}^{T} ]}^{T} . \qquad ( 6 )$$

If the desired complex-valued output parameter vector a, see FIG. 1, is partitioned as

$$a = {[ {a}_{1}^{T} {a}_{c} {a}_{2}^{T} ]}^{T} , \qquad ( 7 )$$

then the first type IBOT is algebraically expressed by the equations

a₁=(1/\sqrt{2})[b_{A,1}+b_{B,2}+j(b_{A,2}−b_{B,1})] (8)

a₂=(1/\sqrt{2})πₖ[b_{A,1}−b_{B,2}−j(b_{A,2}+b_{B,1})] (9)

a_{C}=b_{A,C}−jb_{B,C}, (10)

where j denotes the imaginary unit. According to (8) and (9), each element of the real part and the imaginary part of the complex-valued vectors a₁ and a₂, see (7), are produced by additions of the elements of the vectors b_{A,1}, b_{A,2}, b_{B,1} and b_{B,2} and multiplications with the constant quantity 1/\sqrt{2}. This operation is implemented by IBOTA 330 shown in FIG. 3D, where block 365 represents sign inversion, block S 360 stands for addition and block 380 expresses the multiplication with the constant quantity 1/\sqrt{2}. Blocks 385 and 390 represent the creation of a complex quantity from its real and imaginary part. Furthermore, the central element a_{C} of the complex-valued output vector a is directly extracted from the central elements b_{A,C} and b_{B,C} of the real-valued input vectors b_{A} and b_{B}. This operation is implemented by IBOTB 340 shown in FIG. 3E, where blocks 365, 385 and 390 are described above. The first type IBOT 232 producing the total complex-valued output vector a is illustrated in FIG. 3F, where blocks IBOTA 330 and IBOTB 340 are shown in FIG. 3D and FIG. 3E, respectively.

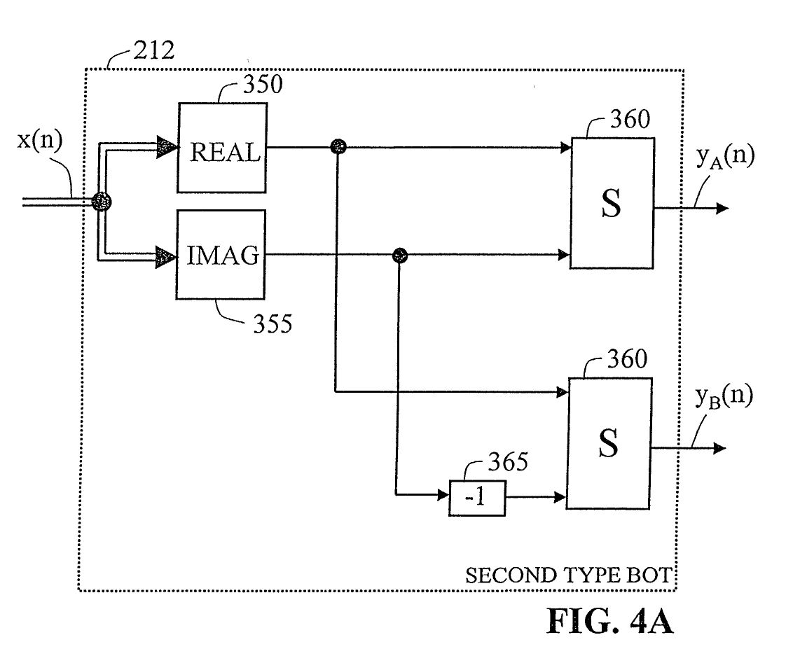

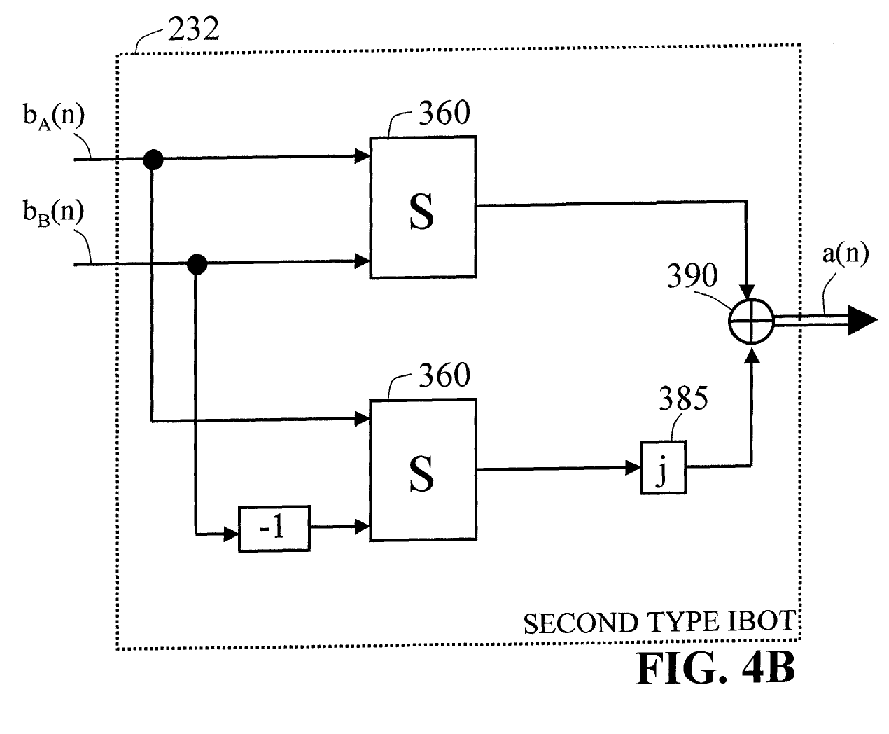

3. BOT and IBOT of the second type (FIG. 4): In this paragraph the details of the BOT 210 and the IBOT 230 of FIG. 2 are explained when the second type of the proposed transformations is used. Consider a complex-valued input vector x of length M, with M being a positive integer. Then, two real-valued vectors y_{A} and y_{B} each of length k can be produced from x by adding and subtracting the real and imaginary parts of the complex-valued vector x, respectively. This operation is algebraically expressed by the equations

$$\begin{matrix}{y}_{A} = Re \{ x \} + Im \{ x \} & ( 11 ) \\ {y}_{B} = Re \{ x \} - Im \{ x \} , & ( 12 )\end{matrix}$$

and its implementation is shown in FIG. 4A (BOT 212), where blocks 350 and 355 apply the operators Re{ } and Im{ } respectively, block 365 represents the sign inversion operation and block S 360 stands for the addition operation.

The counterpart IBOT of the second type BOT is introduced in the following. Let b_{A} and b_{B} express the two real-valued vectors of length M representing the output of the two parallel real LESS of the proposed architecture (see FIG. 2). Then, the IBOT of the second type is algebraically described by the equation

a=(b_{A}+b_{B})+j(b_{A}−b_{B}) (13)

where a is the desired complex valued output parameter vector. This operation is implemented as shown in FIG. 4B (IBOT 232), where block S 360 stands for addition, block 365 expresses sign inversion and blocks 385 and 390 represent the creation of a complex quantity from its real and imaginary part.

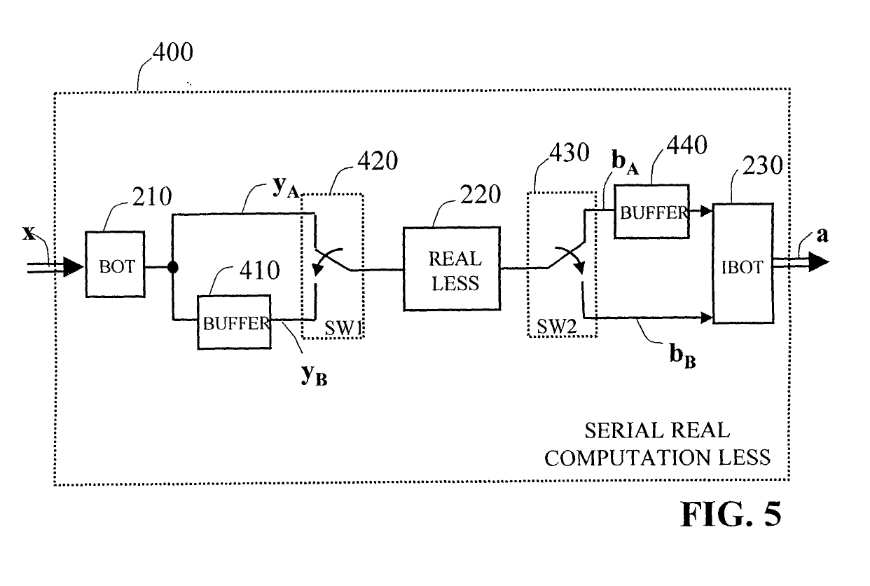

4. Serial Real Computation LESS (FIG. 5): In numerous communication applications periodic or non-periodic training data is used to assist the adaptation process of LESS. This input data is fed in bursts of, e.g., length N. Consequently, instead of using two real computation LESS in parallel (see FIG. 2), we can adopt a serial architecture employing a single real computation LESS. This serial architecture is illustrated in FIG. 5 and is labeled as Serial Real Computation LESS 400. After processing the data in BOT 210, the real computation LESS in block 220 is serially fed by the vectors y_{A} and y_{B}. In order to enable this serial usage of block 220, the combination of a buffer 410 and a Switching Circuit 1 (SW1) 420 is introduced. The buffer 410 stores a sequence of vectors y_{B} of length N. During this time period, the switch of SW1 420 is in the upper position. At the same time, the output vector b_{A} is stored in a buffer 440 with the switch of Switching Circuit 2 (SW2) 430 being in the upper position. After the sequence of vectors y_{A} is fed to the real computation LESS 220, the switch of SW1 420 is moved to the lower position and the sequence of vectors y_{B} is fed to block 220, while the switch of SW2 430 is moved to the lower position. The vectors b_{A} and b_{B} are simultaneously fed to the IBOT 230, exactly as in FIG. 2. The output of the IBOT is the desired complex-valued parameter vector a. Compared to FIG. 2, the proposed method in FIG. 4 leads to more cost-effective implementations on DSPs and VLSI architectures, since the LESS 220 is a highly demanding part of the system in terms of computational complexity and required circuit area. The only penalty in this architecture is a processing latency of N input clock cycles.

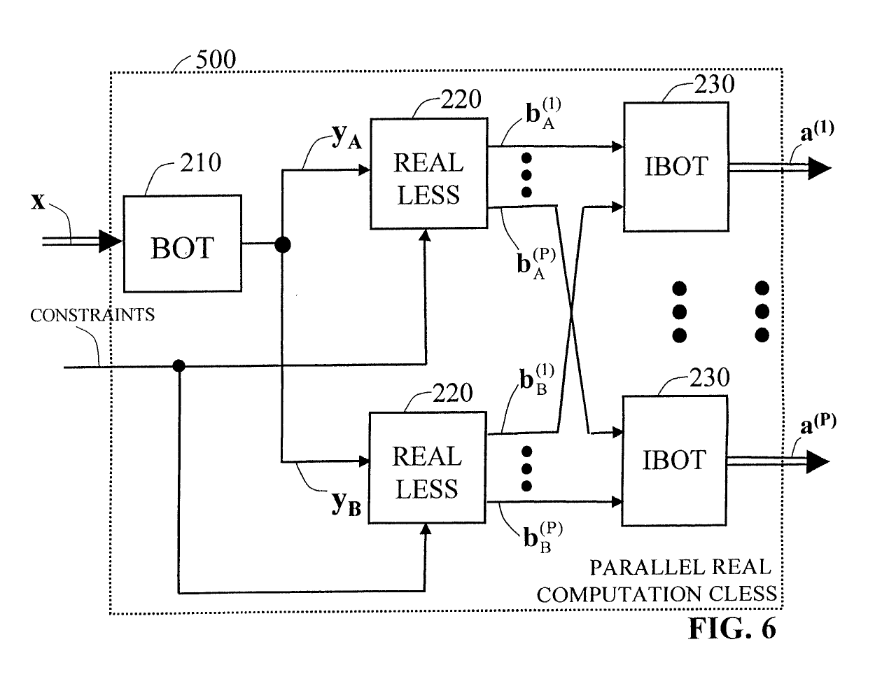

5. Parallel Real Computation Constrained LESS (FIG. 6): There are cases in communications and automation control where a LESS is applied more than one time, say P times, subject to P different constraints. In these cases, from a single observation vector x, P different parameter vectors a^{(p)}, p=1 . . . P, are produced. A Constrained LESS (CLESS) usually operates with complex number arithmetic. In FIG. 6 we show how our method is extended for computing CLESS by using real number arithmetic throughout, except for an initial BOT 210 from complex number arithmetic to real number arithmetic and P final IBOT 230 blocks from real number arithmetic to complex number arithmetic. At the output of each real LESS 220 in FIG. 6 P real-valued vectors b_{A}^{(p)} and b_{B}^{(p)}, p=1 . . . P, are produced and are fed to a bank of P IBOT 230 modules. At the output of each IBOT a specific output parameter vector a^{(p)}, p=1 . . . P, is delivered.

While the particular embodiment of the invention has been described, it will be apparent to those skilled in the art that various modifications may be made in the embodiment without departing from the spirit of the present invention. Such modifications are all within the scope of this invention.

### REFERENCES

[1] S. Haykin, Adaptive filter theory, Prentice Hall, Englewood Cliffs, 2^{nd} Ed., 1991.

[2] E. Frantzeskakis and K. J. R. Liu, “A Class of Square Root and Division Free Algorithms and Architectures for QRD-Based Adaptive Signal Processing”. IEEE Trans. on Signal Processing, vol 42, no 9, pp.2455-2469, September 1994.

[3] K. J. R. Liu, S. F. Hsieh, and K. Yao, “Systolic Block Householder Transformation for RLS Algorithm with Two-Level Pipelined Implementation”, IEEE Trans. on Signal Processing, Vol 40, No 4, pp.946-958, April 1992.

[4] A. Lee, “Centrohermitian and skew-centrohermitian matrices”, Linear Algebra and its Applications, vol. 29, pp. 205-210, 1980.

[5] S. L. Marple, Jr, Digital spectral analysis with applications, Prentice-Hall, Englewood Cliffs, N.J., 1987

[6] A. Klein and P. W. Baier, “Linear unbiased data estimation in mobile radio systems applying CDMA”, IEEE Journal on Selected Areas in Communications, vol. 11, pp. 1058-1066, 1993.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method for adapting a linear systems to a set of observations with a Least Square Solver (LESS) having adaptation parameters with complex-valued elements, comprising the steps of:
transforming said adaptation parameters from a complex arithmetic to two sets of real number arithmetic by means of binary orthogonalization transformation (BOT),
computing with LESS said two sets of real number arithmetic; and
transforming after said computing with LESS said two sets of real number computation to complex number arithmetic using an inverse binary orthogonalization transform (IBOT).

2. The method as described in claim 1, wherein said computing of said two sets of real number arithmetic are applied in parallel.

3. The method as described in claim 1, wherein said computing of said two sets of real number computation LESS are applied in series.

4. The method as described in claim 1, wherein the LESS represents a Recursive Least Squares algorithm (RLS).

6. The method as described in claim 1, wherein the LESS represents a Least Mean Squares (LMS) algorithm.

7. The method as described in claim 1, wherein said LESS is a Householder transformation.

8. The method as described in claim 1, wherein said LESS is a Cholesky decomposition.

9. The method as described in claim 1, wherein said LESS is a Singular Value Decomposition (SVD).

10. The method as described in claim 1, wherein said LESS is a QR Decomposition (QRD).

11. The method as claim 4, wherein the RLS is computed by a systolic array.

12. The method as described in claim 1, wherein the LESS represents the group consisting of a Block Matched Filter Estimator (BMFE), a Block Zero Forcing Estimator (BZFE), and a Block Minimum Mean Square Error Estimator (BMMSEE).

13. The method as described in claim 11, wherein the group is computed through the group consisting of a Cholesky decomposition, a singular value deposition (SVD) and a QR Decomposition (QRD).

14. The method as described in claim 1, wherein said LESS is constrained as CLESS in that an initial BOT from complex number arithmetic to real number arithmetic is used; then two real computation CLESS are applied, each one producing P output streams; and finally a corresponding number of P IBOT modules from real number arithmetic to complex number arithmetic are implemented.

15. The method as described in claim 1, wherein said linear system is applied for the group consisting of temporal, spatial, joint temporal and spatial channel estimation.

16. The method as described in claim 1, wherein said linear system is applied for the group consisting of temporal, spatial, joint temporal and spatial channel equalization.

17. The method as described in claim 1, wherein said linear system is applied for the group consisting of carrier frequency estimation, Direction of Arrival (DOA) estimation, and joint carrier frequency and DOA estimation.

18. The method as described in claim 1, wherein said linear system is an adaptive filter.

19. An apparatus for implementing Least Square Solver (LESS) to adapt a linear system to a set of adaptation parameters, whose elements are complex-valued, comprising:
binary orthogonalization transformation means to transform said elements from complex arithmetic to real number arithmetic;
LESS means to compute said real number arithmetic; and
inverse binary orthogonalization transformation means to transform said real number arithmetic to another complex number arithmetic.
